(19) United States
(12) Patent Application Publication
(10) Pub. No.: US 2015/0122864 A1
(43) Pub. Date: May 7, 2015

(54) CUTTING DEVICE FOR CUTTING LIQUID CRYSTAL SUBSTRATE AND METHOD FOR ADJUSTING KNIFE PRESSURE THEREOF

(71) Applicant: SHENZHEN CHINA STAR OPTOELECTRONICS TECHNOLOGY CO., LTD., Shenzhen (CN)

(72) Inventor: Chunming Pang, Shenzhen (CN)

(21) Appl. No.: 14/241,750

(22) PCT Filed: Jan. 24, 2014
(86) PCT No.: PCT/CN2014/071419

§ 371 Date: Jun. 5, 2014

(30) Foreign Application Priority Data
Nov. 6, 2013 (CN) 201310545398.2

(51) Int. Cl. B26D 7/00; G02F 1/13

(52) U.S. Cl. CPC B26D 7/0006; G02F 1/1303
USPC 225/1; 225/91

(57) ABSTRACT

The present disclosure disclosed a device for cutting a liquid crystal substrate, comprising: a knife head for applying a pressure on a predetermined position of a liquid crystal substrate, so as to faun a cross section with rib marks; an image sensor movably arranged at a proper location to obtain and transmit rib mark images; a drive unit connected with the image sensor, for driving the image sensor to move to or away from a location suitable for obtaining the rib mark images; and an image processing unit communicatively connected with the image sensor, for receiving and analyzing the transmitted rib mark images to obtain the rib mark information on the cross section under the pressure of the knife head. The present disclosure can test the rib mark and automatically adjust the knife pressure prior to cutting the substrate, so as to increase the cutting efficiency.

### FIELD OF THE INVENTION

The invention relates to the field of display technologies, in particular to a device for cutting a liquid crystal substrate and a method for adjusting knife pressure of the device.

### BACKGROUND OF THE INVENTION

At present, most of cutting manners in the industry of panels are a flywheel knife cutting manner, and the cutting manner is to apply a pressure on the substrate by virtue of a flywheel knife 101 (as shown in FIG. 1) so as to break the surface of the substrate to form rib marks, gradually forming vertical cracks 102 by virtue of the concentration of the downward stress of the rib marks, and finally forming crack extensions 105 until the substrate is completely cut off. In FIG. 1, an area in contact with the flywheel knife 101 is a plastic deformation area 103. During a cutting process, there are horizontal cracks 104 except the vertical cracks. FIG. 2 shows the cross section of the substrate after being cut.

In a cutting process, the value of the rib marks on the cross section is one of the most important parameters for judging whether the liquid crystal glass substrate can be successfully cut off or not. The value of the rib marks mainly depends on the following parameters: a knife pressure applied on the liquid crystal glass substrate by the flywheel knife; the sharpness degree, tooth number, tooth depth, and tooth angle of the flywheel knife and the like; and the material and thickness of the liquid crystal glass substrate and the like.

When cutting device is used, engineers may debug a proper range of the knife pressure used for mass production according to the flywheel knife and the glass substrate in use as well as an ideal value of the rib marks. However, with the orientation of the market and the needs of manufacturing, other types of glass substrates need to be led in (for example, replacing a glass with a thickness of 0.7 mm with a glass with a thickness of 0.5 mm), or another novel type of flywheel knife is adopted (for example, a flywheel knife with an angle of 115 degrees is replaced by a flywheel knife with an angle of 125 degrees), and another knife pressure range used for mass production needs to be re-debugged at this moment. From the above, the value of the rib marks is mainly influenced by the knife pressure under the circumstance that the types of the flywheel knife and the glass substrate are determined. Therefore, whether the knife pressure is proper or not can be judged according to the measured value of the rib marks. As a matter of fact, a process of adjusting the knife pressure is also a process of continuously measuring the value of the rib marks.

At present, a measurement for the value of the rib marks is mainly performed manually. In this case, a section of residual materials (which are those glasses between the display panels or on the edge of the display panels in the glass substrate) is first cut off from the glass substrate, and then the residual material is placed under a microscope for measurement.

However, the measurement manner is inconvenient, untimely and materials consuming. In particular, crack abnormity occurs during a production process and the value of the rib marks needs to be measured to judge the reasons of abnormity, which caused shutdown time of the cutting device, and thus reduction of the production.

Therefore, there is a need to design a cutting device which is capable of automatically testing the value of the rib marks of the section and automatically adjusting the knife pressure of the cutting device before cutting the liquid crystal substrate, so as to further increase cutting efficiency and accurately and effectively analyze the reasons of abnormity in case of crack abnormity.

### SUMMARY OF THE INVENTION

One of technical problems to be solved by the present disclosure is to provide a cutting device capable of automatically testing the value of the rib marks of the section and adjusting the knife pressure of the cutting device before the liquid crystal substrate is cut, so as to further increase cutting efficiency, and accurately and effectively analyze the reasons of abnormity in case of crack abnormity.

In order to solve the above-mentioned technical problem, the present disclosure provides a device for cutting a liquid crystal substrate, comprising: a knife head for applying a pressure on a predetermined position of a liquid crystal substrate to be cut, so as to break the liquid crystal substrate at the position to form a cross section with rib marks; an image sensor movably arranged at a proper location to obtain rib mark images on the cross section and transmit the images; a drive unit connected with the image sensor, for driving the image sensor to move to or away from a location suitable for obtaining the rib mark images; and an image processing unit communicatively connected with the image sensor, for receiving and analyzing the transmitted rib mark images to obtain the rib mark information on the cross section under the pressure of the knife head.

According to an embodiment of the present disclosure, the device further comprises a control unit for sending instructions to the drive unit for moving the image sensor to proper locations after the knife head finishes the cutting for the predetermined position and the image sensor obtains the rib mark images, wherein the proper locations comprise a first location suitable for obtaining the rib mark images and a second location without interference on the cutting for the liquid crystal substrate.

According to an embodiment of the present disclosure, the instructions of moving the image sensor to proper locations comprise instructions enabling the drive unit to drive the image sensor to longitudinally move up and down or transversally move back and forth to proper locations along a direction perpendicular to the process flowing direction of the liquid crystal substrate to be cut.

According to an embodiment of the present disclosure, the drive unit comprises: a motor connected with the control unit, for rotating in forward or backward direction at a predetermined speed for a predetermined time according to the instructions sent by the control unit; and a movement unit, with one end being connected with the motor, and a connection element for fixing the image sensor being arranged on the other end, so that the image sensor can perform a corresponding lifting movement or transversal movement in a direction parallel to the cross section according to the rotation of the transmission motor, so as to arrive at the first location or the second location.

According to an embodiment of the present disclosure, the movement unit is configured to be of a screw-and-nut drive mechanism or a worm gear drive structure.

According to an embodiment of the present disclosure, the cutting device further comprises a knife pressure adjustment unit connected with the knife head and in communication with the image processing unit. During operation, the knife pressure adjustment unit adjusts the pressure of the knife head applying on the liquid crystal substrate to be cut based on given liquid crystal substrate parameters, given knife head parameters and the rib mark information transmitted by the image processing unit.

According to another aspect of the present disclosure, a method for adjusting knife pressure of a cutting device for a liquid crystal substrate is further provided, comprising the following steps: cutting the liquid crystal substrate in a certain range of knife pressure; obtaining the cross section images with rib mark information of the liquid crystal substrate; analyzing the cross section images to extract the rib mark information thereon; and judging whether the rib mark information is in an acceptable range or not, if so, then continuing to cut by virtue of the current knife pressure, otherwise, adjusting the knife pressure according to a distance of the value of the rib mark information away from the acceptable range.

According to an example of the present disclosure, the cross section images are obtained by the image sensor arranged on the cutting device.

According to an embodiment of the present disclosure, the knife pressure is adjusted based on the following parameters: liquid crystal substrate parameters, knife head parameters and rib mark information, wherein the liquid crystal substrate parameters comprise substrate material and substrate thickness, and the knife head parameters comprise sharpness, tooth number, tooth angle and tooth depth.

The present disclosure has the beneficial effect that the value of the rib marks can be conveniently, timely and flexibly measured, thus facilitating the adjustment of the cutting parameters, timely providing reference data (the value of rib marks) in case of the problems of crack abnormity and the like, facilitating solving the abnormity problem, and thus improving productivity.

Other features and advantages of the present disclosure will be illustrated in the following description, and are partially obvious from the description or understood through implementing the present disclosure. The objectives and other advantages of the present disclosure may be realized and obtained through the structures specified in the description, claims and accompanying drawings.

### BRIEF DESCRIPTION OF THE DRAWINGS

The accompanying drawings are provided for a further understanding of the present disclosure, constitute a part of the description, and are used for interpreting the present disclosure together with the embodiments of the present disclosure, rather than limiting the present disclosure. In the accompanying drawings:

FIG. 1 shows a state diagram of the generation of cracks when a glass substrate is cut by using a flywheel knife;

FIG. 2 shows a cross section diagram after a glass substrate is cut in the manner as shown in FIG. 1;

FIG. 3 shows a principle diagram of a cutting device used for a liquid crystal glass substrate according to an embodiment of the present disclosure;

FIG. 4 further shows a structural diagram of a cutting device according to the present disclosure in detail; and

FIG. 5 shows a flow diagram of performing knife pressure adjustment according to an embodiment of the present disclosure.

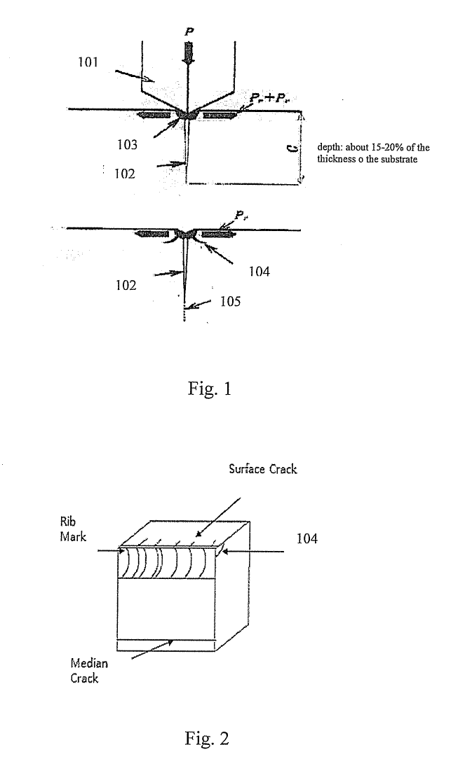

### DETAILED DESCRIPTION OF THE EMBODIMENTS

The embodiments of the present disclosure will be illustrated in detail in conjunction with the accompanying drawings and embodiments, and thus how to use technical means to solve the technical problems and the implementation process of achieving the technical effects may be fully understood and accordingly implemented. It should be noted that as long as conflicts are avoided, all embodiments in the present disclosure and all features in all the embodiments may be combined together, and the fowled technical solutions are within the scope of the present disclosure.

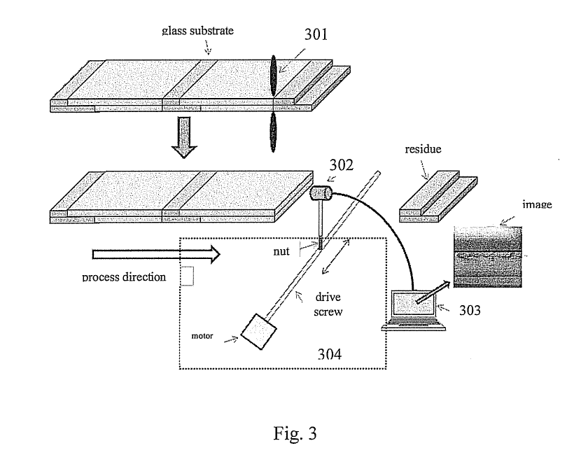

FIG. 3 schematically shows a cutting device for cutting a liquid crystal glass substrate according to an embodiment of the present disclosure. As shown in FIG. 3, the device comprises a knife head 301, an image sensor 302, an image processing unit 303 and a drive unit 304.

The knife head 301 applies a pressure on a predetermined position of a liquid crystal substrate to be cut, so as to break the liquid crystal substrate at the position to form a cross section with rib marks. The predetermined position is a cutting position and determined by cutting process parameters, and the knife head 301 is driven by a knife head drive mechanism to arrive at the position.

Before the normal operation of the cutting device, an initial range of the pressure applied by the knife head needs to be predetermined according to glass substrate parameters and knife head parameters. In the case that the knife head 301 (a flywheel knife in the example) cuts the liquid crystal substrate under an initial pressure, a cross section with rib marks is formed on the liquid crystal substrate.

The liquid crystal substrate parameters comprise substrate material, substrate thickness and the like, and the knife head parameters comprise sharpness, tooth number, tooth angle, tooth depth and the like. If the liquid crystal substrate parameters and the knife head parameters are selected before cutting process, then, generation for the rib marks on the cross section is directly related to the knife pressure. Generally speaking, an ideal value of the rib marks is corresponding to a knife pressure range. By testing the rib mark information on the cross section and judging whether the rib mark information falls into an ideal value range, whether the knife pressure is proper or not can be judged.

In order to obtain the rib mark information of the cross section to judge whether the cutting process parameters are set to be proper or not, the image sensor 302 is arranged on the cutting device of the present disclosure. The image sensor 302 is movably arranged at a proper location to obtain rib mark images on the cross section and transmit the images. As shown in FIG. 3, the image sensor 302 is a charge-coupled device (CCD). The CCD is installed on the drive unit 304. The drive unit 304 is used for driving the image sensor 302 to move to or away from a location suitable for obtaining the rib cross section images.

The drive unit shown in FIG. 3, that is, a motor driving a screw, and thus the CCD can move back and forth in a direction perpendicular to the flowing direction of the glass substrate. In the case that the CCD does not need to work, the CCD can be operated to wait aside. In the case that the value of the rib marks needs to be measured, the CCD can be operated to a corresponding location to measure after the cutting of the flywheel knife is finished and the two cut parts are led away by a machine table. The image processing unit or a CCD image processing system is used for timely processing the section diagram obtained by the CCD.

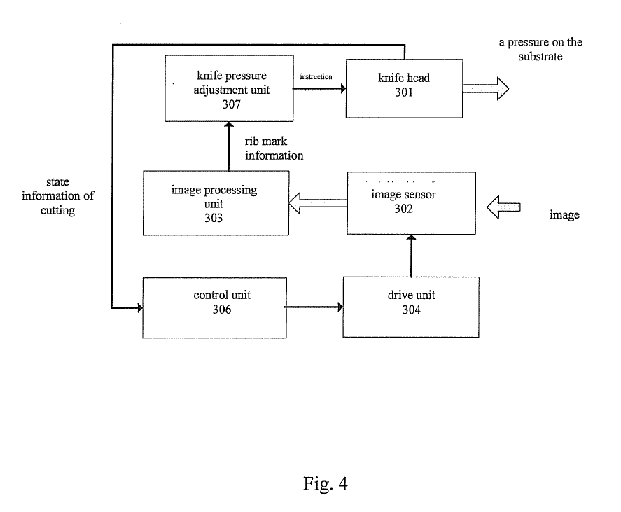

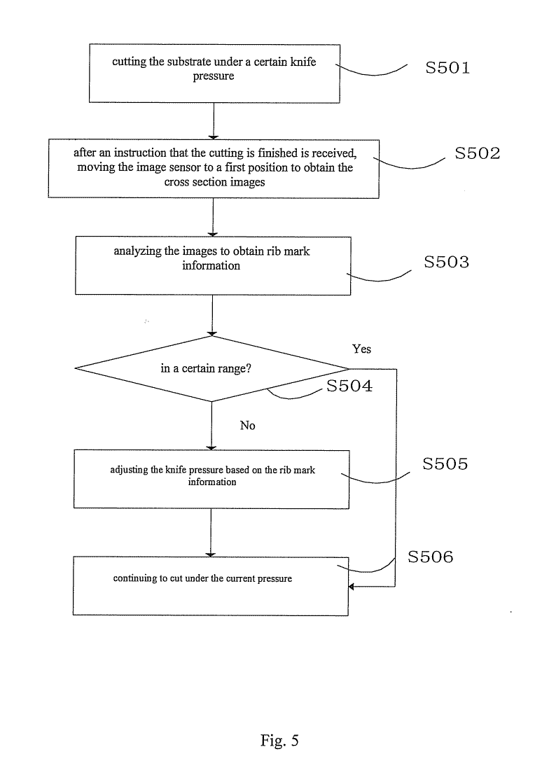

In an example, as shown in FIG. 4, the cutting device further comprises a control unit 306. The control unit 306 is used for sending instructions of moving the image sensor to proper locations to the drive unit after the knife head finishes the cutting operation for the predetermined position and after the image sensor 302 obtains the rib mark images. The proper locations comprise a first location suitable for obtaining the rib mark images and a second location without interference on the cutting operation for the liquid crystal substrate. The instructions of moving the image sensor to proper locations comprise instructions enabling the drive unit to drive the image sensor to longitudinally move up and down or transversally move back and forth to proper locations along a direction perpendicular to the process flowing direction of the liquid crystal substrate to be cut.

Under this circumstance, the drive unit 304 can be implemented in the manner below.

The drive unit 304 comprises a motor connected with the control unit 306 and used for rotating in forward or backward direction at a predetermined speed for a predetermined time according to the instructions sent by the control unit 306; and a movement unit, wherein one end thereof is connected with the motor, and a connection element used for fixing the image sensor is arranged on the other end, so that the image sensor 302 can be correspondingly lifted or transversely in a direction parallel to the cross section according to the rotation of the transmission motor to arrive at the first location or the second location.

Specifically, in an example, the CCD can be installed on a nut as a part of the drive unit 304. The nut can move forwards and backwards along a direction perpendicular to the process flowing direction of the glass substrate under the driving of the motor by virtue of the screw cooperating with the nut. Of course, those skilled in the art can understand that the present disclosure is not limited to such a mechanism, the CCD can also be driven to move up and down along a direction perpendicular to the process flowing direction of the glass substrate in a manner of worm gear structure, for example. As long as the movement is not interfered and the cross section images can be online obtained, the present disclosure can be realized.

In order to analyze the rib mark images captured by the image sensor 302, the cutting device of the present disclosure further comprises the image processing unit 303. The image processing unit 303 can be connected with the image sensor 302 by virtue of a communication link. The image sensor 302 can transmit the rib mark images in any proper communication manner. The image processing unit 303 receives the transmitted rib mark images and analyzes the rib mark images to obtain the rib mark information on the cross section under the pressure of the knife head. After the rib mark images are displayed on the image processing unit 303, the value of the rib marks can be manually measured and judged, or obtained by virtue of analysis software. Any implementation manner can be adopted according to actual conditions, without influencing the scope of the present disclosure.

According to the present disclosure, the image processing unit 303 can also be a personal computer with image processing software installed thereon. But the present disclosure is not limited to this, in the scope of the present disclosure, it is readily conceivable for those skilled in the art that the image processing function can also be realized by using other computing equipment such as a DSP (digital signal processor), an MCU (microprogrammed control unit) and so on.

In an example, as shown in FIG. 4, the cutting device of the present disclosure further comprises a knife pressure adjustment unit 307 connected with the knife head and in communication with the image processing unit 303. During operation, the knife pressure adjustment unit automatically adjusts the pressure applied on the liquid crystal substrate to be cut by the knife head, based on given liquid crystal substrate parameters, given knife head parameters and the rib mark information transmitted by the image processing unit 303.

In addition, the present disclosure further provides a method for adjusting knife pressure of a cutting device for a liquid crystal substrate. The flow diagram of the method is as shown in FIG. 5. In FIG. 5, firstly, cutting the liquid crystal substrate within a certain knife pressure range is executed in step S501. In the case that a knife pressure is adjusted, the control part of the cutting mechanism enables the flywheel knife to apply an initial knife pressure on the substrate to be cut firstly. The initial knife pressure is determined by the cutting mechanism according to the parameters such as the material of the glass substrate and the parameters of the flywheel knife, and cutting the glass substrate is not necessarily ideal under the knife pressure. Therefore, the circumstance of the cross section cut under the initial knife pressure needs to be analyzed next.

In step S502, after cutting is finished, cutting state information indicating that cutting is finished at the moment is sent to a control unit 306 connected with the drive unit 304, so that the control unit 306 sends an instruction to the drive unit 304, so as to drive the CCD image sensor 302 connected with the drive unit to move to a first location suitable for obtaining the cross section images. In the image sensor 302, the cross section images of the liquid crystal substrate with rib mark information are obtained.

In step S503, the cross section images are analyzed to extract the rib mark information thereon. After the rib mark images are displayed on the image processing unit 303, the value of the rib marks can be obtained by a manual measurement or by means of analysis software.

In step S504, whether the rib mark information is in an acceptable range determined by an ideal value or not is judged. If yes, then cutting is continued under the current knife pressure (S506), or else, the knife pressure is adjusted according to a distance of the value of the rib mark information away from the acceptable range (S505).

According to an example of the present disclosure, the knife pressure is adjusted based on the following parameters: liquid crystal substrate parameters, knife head parameters and rib mark information, wherein the liquid crystal substrate parameters comprise substrate material and substrate thickness, and the knife head parameters comprise sharpness, a tooth number, a tooth angle and a tooth depth.

In the case that the value of the rib marks is measured by the existing cutting machine, residual material needs to be placed under a microscope for measurement only, and the limits are too much. However, by using the cutting mechanism and the cutting method of the present disclosure, the limits are few, and the section of the substrate can be directly measured. In addition, the measurement for the value of the rib marks is convenient, in the case that a novel flywheel knife or a novel glass substrate needs to be led in, the cutting machine can conveniently debug the knife pressure, thus reducing the workload of persons, and increasing working efficiency. Another advantage is that during the measurement for the value of the rib marks, in the case that the cutting machine makes a substrate with crack abnormity, the measurement can be timely performed to solve the problem of abnormity and shorten abnormity processing time, thus increasing yield.

Although the embodiments are described above, the foregoing are merely the embodiments for facilitating the understanding of the present disclosure, rather than limiting the present disclosure. Any changes or alternatives conceived by the skilled ones in the art after reading the content disclosed herein will fall within the scope of the present disclosure. Accordingly, the scope of the present disclosure will be defined in the accompanying claims.

What is claimed:

1. A device for cutting a liquid crystal substrate, comprising:
a knife head for applying a pressure on a predetermined position of a liquid crystal substrate to be cut, so as to break the liquid crystal substrate at the position to form a cross section with rib marks;
an image sensor movably arranged at a proper location to obtain and transmit rib mark images on the cross section;
a drive unit connected with the image sensor, for driving the image sensor to move to or away from a location suitable for obtaining the rib mark images; and
an image processing unit in communication with the image sensor, for receiving and analyzing the transmitted rib mark images to obtain the rib mark information on the cross section under the pressure of the knife head.

2. The device as recited in claim 1, wherein the device further comprises a control unit for sending instructions to the drive unit for moving the image sensor to the proper locations after the knife head finishes the cutting at the predetermined position and the image sensor obtains the rib mark images, wherein the proper locations comprise a first location suitable for obtaining the rib mark images and a second location without interfering with cutting the liquid crystal substrate.

3. The device as recited in claim 2, wherein the instructions for moving the image sensor to the proper locations comprise instructions enabling the drive unit to drive the image sensor to longitudinally move up and down or transversally move back and forth to the proper locations along a direction perpendicular to the process flow direction of the liquid crystal substrate to be cut.

4. The device as recited in claim 3, wherein the drive unit comprises:
a motor connected with the control unit, for rotating in forward or backward direction at a predetermined speed for a predetermined time according to the instructions sent by the control unit; and
a movement unit, with one end being connected with the motor, and the other end having a connection element for fixing the image sensor, so that the image sensor is able to perform a corresponding lifting or transversal movement in a direction parallel to the cross section according to the rotation of the transmission motor, so as to arrive at the first location or the second location.

5. The device as recited in claim 4, wherein the movement unit is configured to be of a screw-and-nut drive mechanism or a worm gear drive structure.

6. The device as recited in claim 1, wherein the device further comprises a knife pressure adjustment unit connected with the knife head and in communication with the image processing unit,
during operation, the knife pressure adjustment unit adjusts the pressure of the knife head applying on the liquid crystal substrate to be cut based on given liquid crystal substrate parameters, given knife head parameters, and the rib mark information transmitted by the image processing unit.

7. A method of adjusting knife pressure of a device for cutting a liquid crystal substrate, comprising the following steps:
cutting the liquid crystal substrate in a certain range of knife pressure;
obtaining cross section images with rib mark information of the liquid crystal substrate;
analyzing the cross section images to extract the rib mark information thereon; and
judging whether the rib mark information is in an acceptable range or not, if so, then continuing to cut under the current knife pressure, otherwise, adjusting the knife pressure according to a distance of the value of the rib mark information away from the acceptable range.

8. The method as recited in claim 7, wherein the cross section images are obtained by an image sensor arranged on the device.

9. The method as recited in claim 7, wherein the knife pressure is adjusted based on the following parameters: liquid crystal substrate parameters, knife head parameters and rib mark information,
wherein the liquid crystal substrate parameters comprise substrate material and substrate thickness, and the knife head parameters comprise sharpness, tooth number, tooth angle and tooth depth.
